(19) United States
(12) Patent Application Publication
(10) Pub. No.: US 2002/0170979 A1
(43) Pub. Date: Nov. 21, 2002

(54) Drainage system

(76) Inventor: Victor Martinez, Riverview, FL (US)

Correspondence Address: GREENBERG & LIEBERMAN, 314 PHILADELPHIA AVE., TAKOMA PARK, MD, 20912, US

(21) Appl. No.: 10/063,873

(22) Filed: May 21, 2002

Related U.S. Application Data
(60) Provisional application No. 60/292,018, filed on May 21, 2001.

(51) Int. Cl. B05B 15/06

(52) U.S. Cl. 239/200

(57) ABSTRACT

A drain system for watering plants using run off water from air conditioning units and the like. The system includes a first and second container for water storage, tubing, pump, timer, pump controller, filter, pressure reducer, and emitters for watering the plants. The system can be used to water home lawns or business' planters. The system does not require additional water usage from the user; it merely recycles the drain off from an air conditioning to make the water usable for plants.

### CROSS REFERENCE TO RELATED APPLICATIONS

This application claims priority to provisional application No. 60/292,018 filed on May 21, 2001.

### BACKGROUND OF INVENTION

The present invention is a drainage system attached to an air conditioner condensation coils, or sump pump feed to irrigation tubing and filters for timed watering of plants.

Air conditioning units by nature create moisture and excess water in the functioning of the machinery. In central air or heat pump situations a sump pump that drains the excess water via PVC piping to the outside lawn often controls the drainage. The water often pools in one area, and if the homeowner does not add additional piping, the pool of water can drain too close to the home creating water damage to the foundation of the home.

Japanese patent no. 04,234,925 issued to Tsutomu, et al., on Aug. 24, 1992 shows a system for air conditioning of apparatus for water culture. Tsutomu's invention is unlike the present invention because it is an enclosed area including growth lamps and an air-conditioned environment for growing plants. It does not describe a means of recycling air conditioning water runoff to Water plants.

Japanese patent no. 05,344,828 issued to Tatsuji, on Dec. 27, 1993 shows a water culture system, its plant, greenhouse for the same plant, apparatus for culture with the same water culture system and method for cultivation thereof. Tatsuji's invention is unlike the present invention because it is an enclosed irrigated and air conditioned environment for growing plants, it does not provide a means for filtering the water from an air conditioning unit to water plants in an outdoor setting.

Japanese patent no. 09,308,389 issued to Noriko, et al., on Dec. 2, 1997 shows a plant cultivation system. Noriko's invention is unlike the present invention because it is an enclosed environment for growing plants that is air conditioned and does not describe a means for filtering or reusing the water from and air conditioner to water the plants.

U.S. Pat. No. 5,743,290 issued to Locke, et al., on Apr. 28, 1998 shows a multipurpose automatic filling and leveling liquid basin with liquid transfer. Locke's invention is unlike the present invention because it does not use recycled water from an air conditioning or any other source, and it does not provide a series of set containers to water the lawn or garden on a set schedule.

Japanese patent application no. 11,280,122 issued to Yutaka on Oct. 12, 1999 shows a recycle of dew condensate of air conditioner. Yutaka's invention is unlike the present invention because it is a roof runoff system from a roof based air conditioning unit to terrace or balcony planters. Yutaka's invention uses gravity and piping to water the plants, but would not function from a ground based air conditioning unit.

Japanese patent no. 20,000,209,969 issued to Shunichi, et al., on Aug. 2, 2000 shows a device for culturing plant. Shunichi's invention is unlike the present invention because it is an enclosed planting unit, which uses the air from an air conditioning unit to regulate the temperature for the plants. It does not describe a means for filtering the water run off from the air conditioning to water the plants.

Therefore a need has been established for a system which reuses water run off from an air conditioning or heat pump unit to water a lawn or outdoor garden.

### SUMMARY OF INVENTION

The present invention is a system of using the runoff water from an air conditioning unit to water a lawn or garden in timed intervals and dispersed throughout the lawn or garden. The system includes, preferably, a number of containers for storing water, a pump and filter system, piping, and a timing system to allow the homeowner to set the amount and frequency of the watering.

The first container collects the drain off from the air conditioning unit; either through piping from a conventional sump pump, or as placed under a window air conditioning unit. The first container is connected by piping or tubing to a second container. At the bottom of the second container is the pump and filter system. The pump is attached by piping to a pressure reducer to decrease the pressure of the water before transference to the separate containers for watering the lawn or garden.

The pump system also has a filter to clean the water of possible contaminants from the air conditioner. From the pressure reducer the water is pushed through a series of pipes, or tubing to a series of watering containers dispersed over the lawn or garden. Each of these containers is attached to a dispersal system such as a sprinkler or like device.

The watering containers can be connected to a timing device to water the plants on a regular schedule such as a thirty-minute watering period once each day for three days out of the week. The user can set the watering devices to water as often as they feel necessary. On the installation of the system the user should fill the first tank to begin the watering function of the invention. The air conditioning will continue to fill the first tank over use with run off water, and the initial filling of the first tank is not needed if the user is willing to wait for the air conditioning to drain enough water over time to start the system.

### BRIEF DESCRIPTION OF DRAWINGS

FIG. 1 shows a diagram of the functions of the present invention.

### DETAILED DESCRIPTION

The present invention is a system for recycling drain off water from an air conditioning unit to water a garden or lawn in timed intervals. The system consists of, preferably, three containers, piping or tubing, a pump and filter system and a dispersal system. The first container is placed in direct communication with the air conditioning unit. A second container is placed adjacent to the first container and is connected through piping or tubing to the first container. At the base of the second container is the pump and filter mechanism. The pump sends the filtered water through piping or tubing to a pressure reducer. From the pressure reducer the water runs through tubing to at least one other container that holds the water for timed watering purposes.

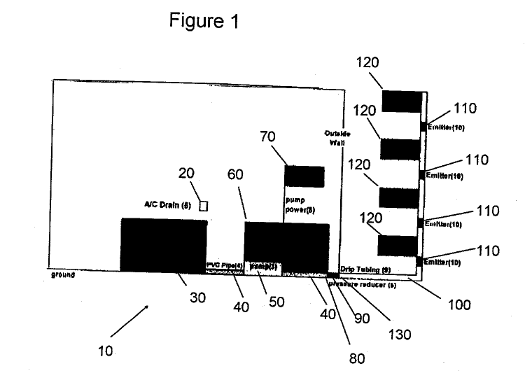

FIG. 1 shows a possible embodiment of the filtration and recycling system for the drain off water. The drainage system (10) starts with the drain (20) for the air conditioning unit. The drain (20) feeds the water drainage from the air conditioning unit to the first container (30) placed on the ground under the drain. From the first container (30) the water drains through PVC piping (40) through a pump (50) to the second container (60). The second container (60) has a pump (50) powered by a control box (70) mounted above the second container (60). The pump (50) regulates the flow of water from the second container (60). The control box (70) for the pump (50) has timing means to regulate when the drain system (10) is activated. The user may choose to water the plants (120) as often as they prefer.

The water flows from the second container (60) by means of the pump (50) through PVC piping (40) to a filter (80) and a pressure reducer (90). The filter (80) purifies the water for use on the plants (120). The filter (80) in this embodiment is a mesh or screen filter of 60 mesh or greater, but the drain system (10) can be manufactured with any applicable filter (80). The pressure reducer (90) ensures that the water is not emitted through the drip tubing (100) at a pressured rate, so the plants (120) are not watered at too rapid a rate. The pressure reducer (90) leads to a vacuum breaker (130). The vacuum breaker (130) ensures that water cannot be emitted through the drip tubing (100) when the pump (50) is not activated. The drip tubing (100) feeds the water at a steady rate to the emitters (110), which disperse the water to the plants (120). The drip tubing (100) and PVC tubing (40) can be buried under the ground to allow the system to go unnoticed to passerby. The emitters (110) can be conventional sprinkler heads, but are not limited thereto.

The drain system (10) allows the user to recycle the water drain off from an air conditioning unit to water plants (120) and can be useful in areas with little rainfall, or water restrictions. Additionally the drain system (10) can reduce water usage costs for home or business owners. The drain system (10) can be used for watering container plants (120) or plants and landscaping not enclosed in containers.

The present invention is not limited to the sole embodiments described above, but encompasses any and all of the embodiments of the following claims.

1. A drainage system, comprising:
at least once storage container;
a pump, in communication with said at least one storage container;
a filter, in communication with said at least one storage container; and
at least one emitter, in communication with said at least one storage container.

2. The system of claim 1, further comprising a timer in communication with said pump.

3. The system of claim 1, further comprising a timer in communication with said emitter.

4. The system of claim 1, wherein said at least one storage container collects water draining from an air conditioning unit.

5. The system of claim 1, further comprising a sump pump in communication with said at least one storage container.

6. The system of claim 1, further comprising a secondary container housing said pump.

7. The system of claim 1, further comprising a secondary container housing said filter.

8. The system of claim 6, wherein said secondary container houses said filter.

9. The system of claim 1, further comprising a pressure reducer in communication with said pump.

10. The system of claim 1, further comprising at least one sprinkler in communication with said at least one emitter.

11. The system of claim 1, wherein said at least one storage container comprises a liquid collection tank and a final holding tank.

12. The system of claim 11, further comprising a timer in communication with said liquid collection tank.

13. The system of claim 11, further comprising a timer in communication with said final holding tank.
